(19) United States
(12) Patent Application Publication
(10) Pub. No.: US 2025/0173883 A1
(43) Pub. Date: May 29, 2025

(54) REAL-TIME, HIGH-QUAILTY, AND SPATIOTEMPORALLY CONSISTENT DEPTH ESTIMATION FROM TWO-DIMENSIONAL, COLOR IMAGES

(71) Applicant: Yao Xue, Westlake Village, CA (US)

(72) Inventors: Yao Xue, San Diego, CA (US); Caoyang Jiang, San Diego, CA (US); Antonios Armaou, State College, PA (US); Anthony Tran, San Diego, CA (US)

(21) Appl. No.: 18/962,749

(22) Filed: Nov. 27, 2024

Related U.S. Application Data
(60) Provisional application No. 63/603,062, filed on Nov. 27, 2023.

(51) Int. Cl. G06T 7/55; G06T 3/18; G06T 5/70; G06T 7/174

(52) U.S. Cl. CPC G06T 7/55; G06T 3/18; G06T 5/70; G06T 7/174; G06T 2207/10024; G06T 2207/20164

(57) ABSTRACT

A system and method for real-time, spatiotemporally consistent depth estimation, the method comprises detecting features present in a pair of images created by a pair of cameras, within those features, detecting human features. The method further comprises relying upon an immediately prior frame of video to generate a warped depth map based upon detected motion between frames. Thereafter, a depth estimate is prepared along with a confidence map for the estimated depth of each pixel. Then, the depth estimate is refined using neighboring views from neighboring cameras and a corresponding depth estimation process. The resulting depth estimate is smoothed using a Gaussian noise reduction process. Much of the method may be or involve the application of specially-trained neural networks.

### RELATED APPLICATION INFORMATION

This patent claims priority from U.S. provisional patent application No. 63/603,062 entitled “SYSTEM AND METHOD FOR REAL-TIME, HIGH-QUALITY, AND SPATIOTEMPORALLY CONSISTENT DEPTH ESTIMATION USING RGB IMAGES” filed Nov. 27, 2023, the entirety of which is incorporated by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates generally to systems and methods for video capture of physical, real-world environments and, more particularly, to the real-time, high-quality, and spatiotemporally consistent depth estimation from two-dimensional, color images for the creation of volumetric video.

### Description of the Related Art

In computer graphics, three-dimensional interactive environments, such as computer gaming environments, are traditionally hand-created. These environments use a series of vertices to form surfaces of models for rooms, objects, characters, and often the player avatar. These models are then “skinned” with “textures” which in the context of computer graphics means two-dimensional graphics “wrapped” around these models. The resulting objects have shape (e.g. the model) and have elements that appear to give them color and shadow (e.g. the textures).

Increases in graphical fidelity and compute power have resulted in the steady increase in the number of vertices to increase the complexity and photo-realism of these models. Simultaneously, textures have increased in complexity and elements such as shaders and dynamic lighting have been added to computer graphical engines to enable more realistic shadows and lighting. Intelligent ray-tracing has enabled reflections and the ability to not-render portions of models that are not visible from the perspective of the viewer or in-game “camera.”

All of these capabilities have dramatically increased graphical fidelity and player immersion in video games and similar (e.g. virtual reality or mixed reality) environments in the last twenty years. The best of these environments appear photorealistic and nearly if not actually indistinguishable from actual, physical environments. However, these environments are either hand-crafted by talented artists and three-dimensional modelers, or more recently, may be created and filled by or with the aid of artificial intelligence.

The ability to accurately capture three-dimensional, real-world environments has only recently become possible. The only way to “capture” the real world has been through the use of camera technology which is limited to two-dimensions, either fixed (e.g. a still camera) or moving (a motion picture camera). Within these captures of the real world, movement of the viewer position and perspective was impossible. The viewer had been limited to the position and perspective chosen for the capture by the director or photographer at the time of creation.

Most-recently, the application of photogrammetry and depth-sensing technology has enabled the capture of so-called “volumetric video.” As used herein, “volumetric video” is video of a captured real-world location, reliant upon two-dimensional camera capture and which includes moving video images and corresponding regularly-updating depth data associated with the scene being captured. To perform this type of capture, multiple sets of two-dimensional camera pairs are used, from different perspectives. Depth sensing technology may also be used to identify the general shape and location of objects within the scene. Thereafter, the images may be combined using photogrammetry techniques and the depth data captured (or otherwise generated) to create a three-dimensional environment, reflective of the real-world location captured, in which a user or player avatar may move about.

The computational resources to generate moving video in three-dimensions is exceptionally high by current standards. Integrating the vertices detected, generating appropriate models, and updating textures wrapped on those models is taxing to current systems. Further, the amount of data necessary to transmit information for subsequent viewing is very high. Accordingly, various methods to improve, and make more efficient, the processes of capture, rendering, transmission, and reproduction of the volumetric video have been devised.

One necessary process in the generation of volumetric video is the creation of depth information from the images created by the camera pairs used to capture volumetric video. This information can be captured directly, but doing so for each frame of volumetric video in a series of camera pairs is data-intensive and computationally intense. Accordingly, one option is to utilize depth As used herein, “estimation” or “depth estimation” means a depth-from-camera determination for a given two-dimensional image. Depth estimation is distinct from depth measurement, which relies upon suitable sensors to physically measure or otherwise determine a depth or to generate a point-cloud-based three-dimensional model for the environment being captured. for some or all frames of volumetric video. Depth estimation is a fundamental problem in computer vision that involves the estimation of the three-dimensional structure of a scene from a two-dimensional perspective. It has numerous applications in fields such as autonomous vehicles, robotics, and volumetric videos. Traditionally, depth estimation was achieved using stereo matching of hand-crafted features extracted from images of two adjacently placed cameras. Recently, deep learning approaches have been developed for depth estimation, which has shown state-of-the-art performance. These deep learning approaches involve training a neural network on a large dataset of image-depth pairs, where the network learns to predict the depth map from input images. The new approaches significantly mitigate issues that occur in traditional methods, such as higher tolerance to noise and better adaptation to feature-less areas.

There remain multiple challenges in the field of depth estimation, especially for real-time volumetric video capturing. The first challenge is the variation of the estimation from frame to frame, which causes unstable reconstruction of the 3D shapes and a jiggering visual effect. Another challenge is the inconsistency of depth estimation among multiple perspectives, which may cause a deformed three-dimensional shape or loss of important character features. Third, depth estimation models require significant computational resources, which scale exponentially with the resolution of images being processed. In the meantime, processing of higher resolution images is crucial to high-quality volumetric capturing which requires refined features and abundant room for the character to move.

### DESCRIPTION OF THE DRAWINGS

FIG. 1 is a block diagram overview of a system for real-time, high-quality, spatiotemporal depth estimation from two-dimensional, color images.

FIG. 2 is a block diagram of a computing device.

FIG. 3 is a functional block diagram of a system for real-time, high-quality, spatiotemporal depth estimation from two-dimensional, color images.

FIG. 4 is a flowchart of a process for generation of real-time, high-quality, spatiotemporal depth estimation from two-dimensional, color images.

FIG. 5 is a flowchart of a process of coarse depth estimation.

FIG. 6 is a flowchart of a process of multi-start, semi-global feature matching.

FIG. 7 is a flowchart of a process of cross-view refinement.

Throughout this description, elements appearing in figures are assigned three-digit reference designators, where the most significant digit is the figure number where the element is introduced, and the two least significant digits are specific to the element. An element that is not described in conjunction with a figure may be presumed to have the same characteristics and function as a previously-described element having the same two least significant digits.

### DETAILED DESCRIPTION

The processes and systems described herein provide depth information for objects within volumetric video reliant upon the absolute location of each object within a volumetric video scene being captured or that has been captured need not be absolutely derived for each frame of volumetric video. This generated depth data is extremely dense and its generation for every pixel in a given image—for multiple image pairs and for tens of frames per second in volumetric video—is sufficiently computationally intense to be a bottleneck in the overall volumetric capture process.

Currently, the most popular depth estimation method for volumetric capturing purposes is to utilize off-the-shelf depth cameras including Intel® RealSense®, Microsoft® Azure Kinect®, and other dedicated volumetric cameras. These cameras are computationally efficient, small in form factor, and utilize structural light to enhance estimation accuracy. Most of these cameras are packaged with depth estimation algorithms or models that work with their hardware configuration. The primary drawback of these dedicated volumetric cameras is that the quality is not good enough for high-resolution volumetric capture and their capability is fixed so there is very limited space to build further enhancement. There are other robotics or auto-driving-oriented depth estimation methods that produce temporally coherent real-time estimations, but those applications rarely provide high-resolution outputs and refined details. There also exist also depth estimation methods in the indoor structural scanning industry that utilizes a conventional photo-geometric method called multi-view stereo (MVS) to achieve cross-view agreement among different perspectives and enhance the overall accuracy. However, MVS is a computationally heavy algorithm that cannot be easily applied in a real-time system.

the deep learning-based stereo-matching depth estimation models described herein are generally structured as follows. A Convolutional Neural Network (CNN) based feature extractor is designed to turn input images into feature maps that are easier for models to compare and match, and sometimes an attention mechanism-based module is applied afterward to enhance the key features for a higher matching quality. A correlation map or cost volume is constructed between the left and right views of the camera pairs utilizing the generated feature map. A feature-matching module is designed to find the best match of each pixel in the left view to another pixel in the right view and form a matching flow map. By applying the camera parameters, one can easily convert the matching flow map into a depth map. As used herein, the phrase “depth map” means a two-dimensional array with data in that array representing the actual or estimated depth (e.g. distance to pixel from the perspective of the camera in the real-world, three-dimensional environment represented by the array. Each depth map corresponds to a single two-dimensional image or to a set of image pairs of the real-world, three-dimensional environment. To further reduce the computational overhead and enhance the matching accuracy, a hierarchical model structure is usually implemented, which tries to match the features in multiple resolutions from low to high and combines the results to form one final estimation. A model can be quantized and converted from processing floating point values to 8-bit integer values to further reduce the computation load in exchange for a compromised accuracy.

### Description of Apparatus

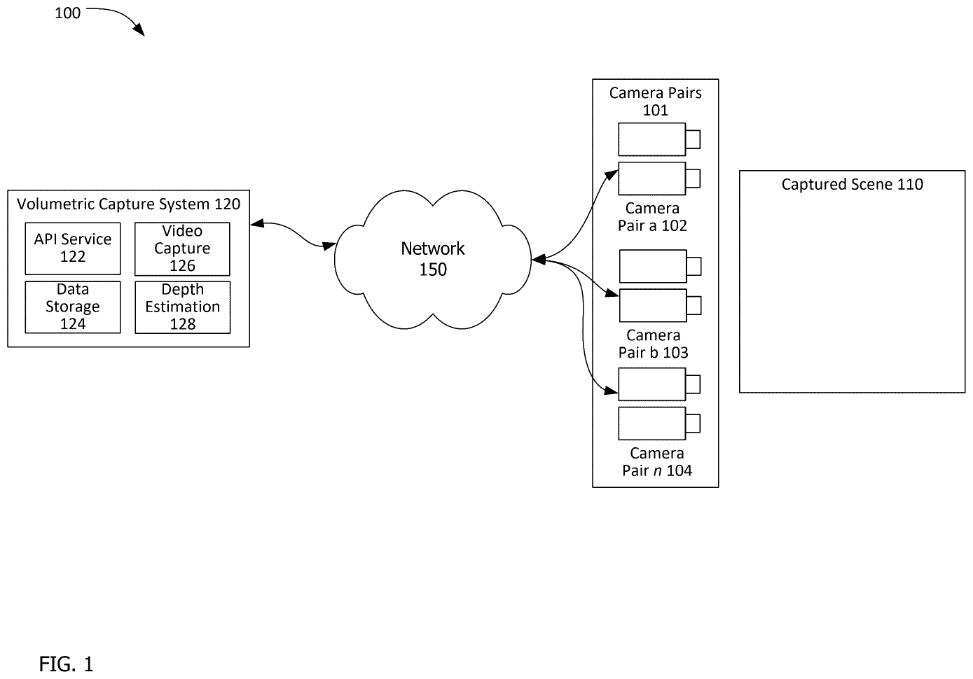

FIG. 1 is a block diagram overview of a system 100 for real-time, high-quality, spatiotemporal depth estimation from two-dimensional, color images. FIG. 1 includes a plurality of camera pairs 101, a captured scene 110, a volumetric capture system 120, interconnected by an electronic computer and/or communication network 150 (e.g. the internet). The system 100 is used to capture video of the captured scene 110 and to generate volumetric video therefrom.

The camera pairs 101 are a plurality of camera pairs, here including camera pair a 102, camera pair b 103, and camera pair n 104. These camera pairs 101 are representative of a plurality of cameras and may be two or three or up to 1000 cameras. The camera pairs 101 are pairs because two pairs of cameras are used from each camera pair location, typically within a camera rig having a known distance between each camera pair of the camera pairs 101 and with known differences between the (e.g., focal distance, exposure aperture, field of view width of) lenses of each camera pair a 102, b 103, and n 104. Each pair or all of the pairs of cameras may be pointed towards, centered on, focused on and/or set to properly image scene 110 or an object in that scene. Knowing all of these relative positions at the time of capture enables the volumetric video capture software system, programmed accordingly, to utilize photogrammetry techniques to properly estimate depth and dimensionality of the captured scene 110. The camera pairs 101 typically communicate with the volumetric capture system 120 through a network 150, but may merely store data for later transmission or upload to the volumetric capture system 120. The camera pairs 101 may include depth sensors (e.g. lidar sensors or structured light sensors) to capture, periodically or regularly, depth information for the captured scene 110. The depth information may be captured with each image of each camera.

The captured scene 110 is a typical, real-world scene. It may be a waterfall in Vietnam, an interior space in a warehouse, an ongoing Hindu festival in an outdoor temple, or virtually any scene, indoor or outdoor, having depth, lighting, and capable of being captured in two-dimensional video. It is not a computer generated scene or a scene on an analog or digital display (although it may include one, such as a digital billboard).

The volumetric capture system 120 is a computing device (or several, capable of interaction one with another, possibly over a network like network 150) which includes an API (application programming interface) service 122, data storage 124, video capture 126, and depth estimation 128. The volumetric capture system 120 is simplified intentionally to focus on those elements that are relevant to this patent.

The API service 122 is software operating on the volumetric capture system 120 may serve many functions, such as enabling exterior devices to connect to, control, interact with and operate upon the volumetric capture system 120. These activities may include control over (e.g., pointing direction, field of view, focus, imaging speed, etc. of) the camera pairs 101, review or editing of volumetric video in data storage 124, offloading or accessing captured video or depth data (e.g., depth information) in the data storage 124, and/or various other functions. The camera pairs 101 themselves may interact with the volumetric capture system 120 through the API service 122.

The data storage 124 is physical or virtual storage (e.g. cloud storage) is used to store the captured two-dimensional video generated by camera pairs 101, as well as any generated volumetric video, and any captured or estimated depth data, such as that generated by the depth estimation 128.

The video capture 126 is software operating upon the volumetric capture system 120 that is used to receive and handle or process video generated by the camera pairs 101. The video capture 126 may also be responsible for combining the two-dimensional videos captured by the camera pairs 101 and converting them into stereoscopic and/or volumetric video for storage in the data storage 124.

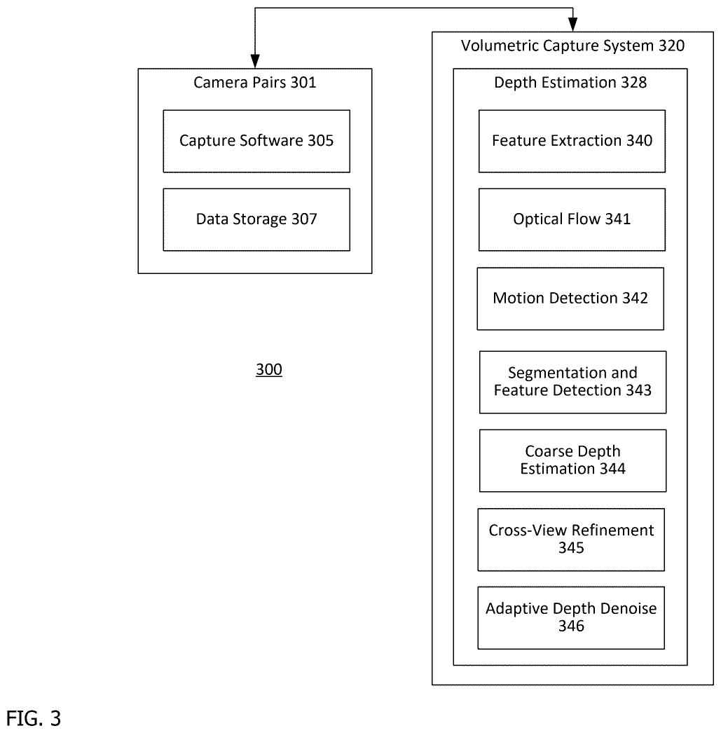

The depth estimation 128 is software operating upon the volumetric capture system 120 that may both capture depth data from the camera pairs 101 and perform depth estimation based upon the two-dimensional video and other data available from the camera pairs 101. This is the primary system which will be discussed herein with reference to FIGS. 3-7. This software may be or be from a non-transitory memory such as computer instructions stored on a disc, server or flash memory.

The network 150 is a computer hardware and software system for enabling communication between the various elements of the system 100. The network 150 may be or include the internet, but may also include so-called 802.11x or Bluetooth® wireless communications, ethernet connections, direct serial connections (e.g. USB-C), or special connections designed for high-bandwidth video data transmission.

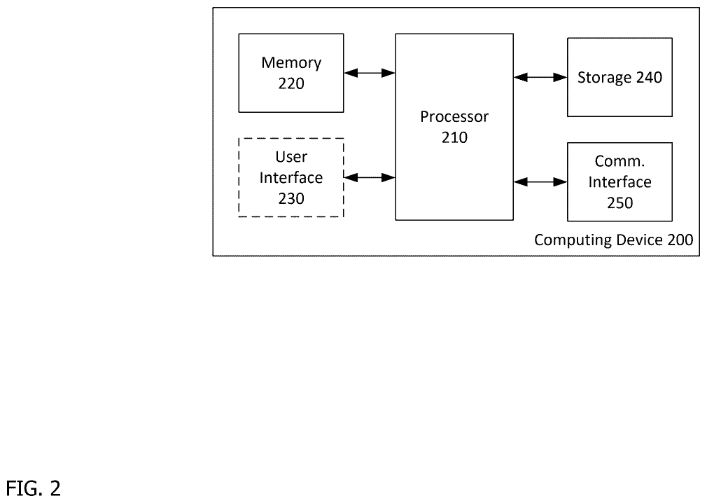

Turning now to FIG. 2, is a block diagram of an exemplary computing device 200, which may be the volumetric capture system 120 of FIG. 1. And, as shown in FIG. 2 as a single device 200, the computing device 200 may in fact be many computing devices or systems, integral or in communication with one another, operating in concert, such as separate computing devices operating across a computer network. The computing device 200 may be or have one or more systems, computer instructions, processes and/or devices configured to perform any, some or all of the functions of embodiments described herein for volumetric capture and/or depth estimation.

As shown in FIG. 2, the computing device 200 includes a processor 210, memory 220, optionally, a user interface 230, along with storage 240, and a communications interface 250. Some of these elements may or may not be present, depending on the implementation. Further, although these elements are shown independently of one another, each may, in some cases, be integrated into another.

The processor 210 may be or include one or more microprocessors, microcontrollers, digital signal processors, application specific integrated circuits (ASICs), or a systems-on-a-chip (SOCs). The memory 220 may include a combination of volatile and/or non-volatile memory including read-only memory (ROM), static, dynamic, and/or magnetoresistive random access memory (SRAM, DRM, MRAM, respectively), and nonvolatile writable memory such as flash memory.

The memory 220 may store software programs and routines for execution by the processor. These stored software programs may include an operating system software. The operating system may include functions to support the communications interface 250, such as protocol stacks, coding/decoding, compression/decompression, and encryption/decryption. The stored software programs may include an application or “app” to cause the computing device to perform portions of the processes and functions described herein. The word “memory”, as used herein, explicitly excludes propagating waveforms and transitory signals.

The user interface 230, if present, may include a display and one or more input devices such as a mouse, touch screen, keypad, keyboard, stylus or other input devices.

Storage 240 may be or include non-volatile memory such as hard disk drives, flash memory devices designed for long-term storage, writable media, and proprietary storage media, such as media designed for long-term storage of photographic or video data. The word “storage”, as used herein, explicitly excludes propagating waveforms and transitory signals.

The communications interface 250 may include one or more wireless (e.g., WIFI or Bluetooth), wired interfaces (e.g. a universal serial bus (USB), high-definition multimedia interface (HDMI)), one or more connectors for storage devices such as hard disk drives, flash drives, or proprietary storage solutions. The communications interface 250 may also include a cellular telephone network interface, a wireless local area network (LAN) interface, and/or a wireless personal area network (PAN) interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The cellular telephone network interface and/or the wireless LAN interface may be used to communicate with devices external to the computing device 200.

The communications interface 250 may include radio-frequency circuits, analog circuits, digital circuits, one or more antennas, and other hardware, firmware, and software necessary for communicating with external devices. The communications interface 250 may include one or more specialized processors to perform functions such as coding/decoding, compression/decompression, and encryption/decryption as necessary for communicating with external devices using selected communications protocols. The communications interface 250 may rely on the processor 210 to perform some or all of these function in whole or in part.

As discussed above, the computing device 200 may be configured to perform geo-location, which is to say to determine its own location. Geo-location may be performed by a component of the computing device 200 itself or through interaction with an external device suitable for such a purpose. Geo-location may be performed, for example, using a Global Positioning System (GPS) receiver or by some other method.

FIG. 3 is a functional block diagram of a system 300 for real-time, high-quality, spatiotemporal depth estimation from two-dimensional, color images. The system 300 includes the camera pairs 301 (e.g., pairs 101), focusing only on the functional elements, and the volumetric capture system 320 (e.g., system 120) of FIG. 1, but focuses on the depth estimation 328 (e.g., depth estimation 128).

The camera pairs 301 are each pair used to capture two corresponding side-by-side images of two-dimensional video for use in creating volumetric video. The capture software 305 present on each camera or camera pair typically uses a digital complementary metal oxide semiconductor (CMOS) image sensors to generate data representative of a two-dimensional image being captured. The camera pairs 301 may also include lidar or other structured light systems for capturing depth data, using the capture software 305. Each of the camera pairs 301 also includes data storage for temporarily (or until transmitted to system 120/320) storing the image and depth data captured by the camera pairs 301.

The camera pairs 301 may store data in data storage 307 for later transmission or upload to the volumetric capture system 320.

The volumetric capture system 320 is the volumetric capture system 120 of FIG. 1, such as for volumetric capture and/or depth estimation. It is used to capture volumetric video by combining the two-dimensional image data generated by the camera pairs and any associated depth data, as well as performing other functions (described herein) for simplifying or making that process more efficient.

The depth estimation 328 is the system responsible for estimating depth, as opposed to measuring it using one of the hardware and/or software tools capable of doing so. The depth estimation operates in computer instructions or software within the volumetric capture system 320, but aspects of the system may be implemented in whole or in part in computer hardware. The depth estimation 328 can operate in real-time, alongside the capture process, but preferably operates upon already-captured two-dimensional image data captured by one or more camera pairs to speed up the volumetric video generation process after two-dimensional image data has been captured (e.g., instead of waiting as the images are captured). The processes involved will be discussed more fully below, but the functional systems for accomplishing those processes are discussed with reference to this FIG. 3.

The feature extraction 340 function is preferably a convolutional neural network (CNN) that is trained upon a set of two-dimensional images or image pairs and associated feature maps to thereafter act as a filter to receive two-dimensional images or image pairs and transform them into a stack of maps of detected features. As used herein a “feature map” is a two-dimensional pixel array, preferably in color, that identifies “features” within an image or pair of images. The “features” are unique aspects of the image that may be detected by computer vision (e.g. darker patches of color, human faces, human features, outlines of shapes). These types of features can be used to correspond each image in an image pair (created by the pairs of cameras used for capture of volumetric video) to identify which pixels correspond for use in generating photogrammetry-based volumetric video.

The associated two-dimensional feature map stacks may individually identify one feature of varying sizes and shapes and complexities, such as identifying a person or object in images from different distances or points of view of the person or object. A secondary process may be applied to the feature maps to emphasize the most significant features present within the feature maps. These significant features may be used later in the process to identify the most important features to resolve or where less-important features are present to prioritize depth estimation in certain portions of the image.

The optical flow 341 function is designed to estimate the size and direction of movement from frame-to-frame of two-dimensional video. This is preferably based upon the feature maps created by the feature extraction function 340, and the immediately-preceding frame of video feature maps. In effect, the optical flow 341 uses a feature map set at time t and a feature map set at time t−1 to detect the same set of features and estimate the change over that time t−1 (or a longer period of time, t−n). The optical flow thereby generates a warped depth map, e.g. a depth map based upon a prior frame of video that has been altered by application of the same warp present for the feature map, for subsequent use in depth estimation as discussed below. This warped depth map is likely close to accurate, if the features remain largely consistent, which is typically the case in volumetric video unless there is a hard cut between scenes, such as an I frame.

The motion detection 342 function is preferably an artificial neural network (NN) or artificial intelligence engine that is trained on two dimensional data and depth data for two, immediately adjacent frames of volumetric video and, after training, receives feature maps and a set of saliency maps (discussed below) for time t and t−1 and outputs a motion intensity map (MIM) identifying where motion is present between the two frames for time t and t−1. By identifying where motion has happened relative to the last frame, the depth estimation system (e.g., the function of detection 342) can concentrate (and perform more iterations of any depth estimation processes) on areas where motion is present. It is likely that locations where motion is not present have maintained the same depth as the last frame, given the nature of video capture and real-world spaces. This helps to save computational power later in the process.

The segmentation and feature detection 343 functions also preferably rely upon an artificial neural network trained to accept feature maps generated by feature extraction 340 and to generate a unified saliency map identifying important features. That can be partially-completed by the feature extraction 340 function and completed by the segmentation and feature detection 343. The saliency map is a variation on a feature map that focuses on intelligently identifying human faces, hands, and facial features (e.g. eyes, eyebrows, ears, hair, mouth, arms, hands, etc.). When watching video, much less volumetric video, viewers tend to focus on humans and human facial features and hands are very expressive. So, properly estimating their depth is important. Failing to do so accurately can result in significant undesired visual artifacts readily noticeable by a viewer.

The segmentation and feature detection 343 functions operate to first identify an overall location of a character within the frame of video/image. In some cases, the coarse depth estimation 344 relies upon this data to reduce computation cost by estimating only areas where human characters are present. Thereafter, the important features of that human are identified to provide that information to subsequent rendering processes. The mesh complexity for human models is intentionally more-complex because viewers will notice a “blocky” character or a person more that is more blocky than a blocky desk or background item.

Next, the segmentation and feature detection 343 functions operate to output an alpha matte identifying the character location because the alpha matte may be used as a shape-by-silhouette (SFS) process and may be used to denoise a merged point cloud for the entire scene. Differences in depths typically are most-pronounced near the silhouette of the character(s) within a given scene (e.g. character in the foreground, and the background typically significantly back in the background from the character). So, the alpha matte may be used to very accurately differentiate the foreground from the background. Finally, the alpha matte is also provided to the motion detection 342 function to assist in identifying motion of the character(s) in the scene and thereby assist in creating the motion intensity map.

The coarse depth estimation 344 functions are based again upon an artificial neural network The coarse depth estimation operates reliant upon outputs from the various other systems (e.g., functions 340-343) to combine those outputs into a unified depth map for a given pair of images (within a set of image pairs making up a two-dimensional stream of paired video data).

First, the coarse depth estimation 344 functions attempt to apply a partial depth updating mechanism that focuses on only updating depth where human parts (e.g. a character, hands, arm, head, face, etc.) exist within the frame. This significantly saves in processing power and applies the available processing power to the most-important portion of the images to a viewer. This relies upon the output of the feature extraction 340 and segmentation and feature detection 343 functions. As a result, the system can tackle higher resolution and more motion for a given human character in the scene without significant impact on computational cost. As noted, this is not provided by other systems.

Next, the coarse depth estimation 344 functions rely upon a motion sensitive searching mechanism which elects how to process a particular portion of an image based upon selective application of processing power where motion occurs. This relies upon the output of the motion detection 342 functions. Where motion is present, more iterations of depth estimation are applied. Where motion is not present—e.g. background or non-moving objects from the last frame of video—temporal accumulative depth updating, namely, slight variations based upon a prior depth estimation and perhaps many prior depth estimations may be used for less computational overhead. If motion is very intense, a full depth estimation mechanism may be applied.

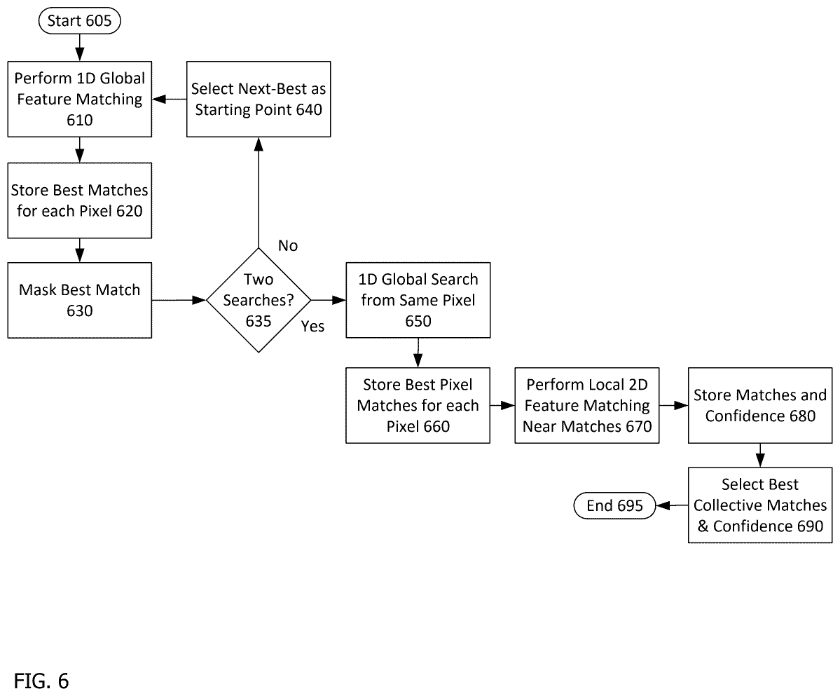

In such cases where full depth estimation is required (e.g. where there is no prior frame of video or the video has a hard cut or where motion is more than a predetermined threshold), then the system 300 cannot rely upon a depth map from t−1. This process will be discussed with reference to FIG. 6.

Upon completion of operation of the coarse depth estimation 344 functions, a coarse depth map is output along with a confidence map providing an estimate of the confidence the system or process has in the estimated depth for each pixel in the coarse depth map. The coarse depth map is likely fairly accurate, but further refinement, particularly to reduce undesired jiggering and undesired unusual depth artifacts may be helpful. The confidence map may be used later to reduce noise, particularly for pixels where the depth estimate is not very confident.

The cross-view refinement 345 functions operate upon this coarse depth map to address undesired jiggering and artifacts. Cross-view refinement 345 functions utilize the availability of other, nearby camera pairs to attempt to identify corresponding pixels within the overall volumetric video, particularly those pixels that may not be visible in one of the images of the camera pair used to create the coarse depth map. In such cases, the depth estimation can be quite wrong (e.g. if pixels cannot be compared using photogrammetry because one pixel is not visible to one of the cameras in the camera pair, then the depth estimation often will be poor). To address this limitation, a point cloud (generated from the depth map) from a neighboring camera pair may be used to extrapolate the questionable pixel and generate a correlation map to compare the two pixels for their relative depth/location. The camera pair for which that depth is visible (e.g. the pixel is not occluded in both views) will be taken as true over a partially-occluded depth which may be very much incorrect. These functions also operate to reduce disagreement across camera pairs by somewhat operating as a smoothing function, which reduces undesired artifacts, particularly for not-known pixel depths.

The adaptive depth denoise 346 function is another artificial neural network which relies upon the confidence map created by the coarse depth estimation 344 functions. The coarse depth map may incorporate Gaussian noise or otherwise not-that-accurate depth estimates, particularly for low light situations. A Gaussian filter is applied to the coarse depth map to smooth areas where confidence is low, but to leave areas where confidence is high largely untouched. This smooths the overall depth map, while not over-smoothing through areas to lose detail and reduce feature loss for the resulting three-dimensional model.

Each of functions 340-346 may be provided by a separate NN. Any one or more of functions 340-346 may not be provided by a NN, which the rest of the functions are provided by a NN.

### Description of Processes

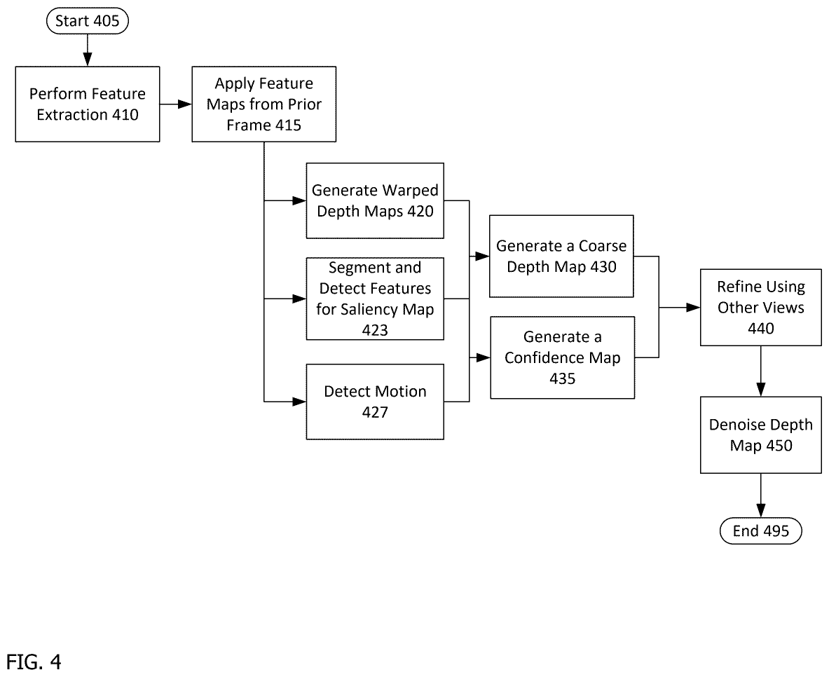

FIG. 4 is a flowchart of a process for generation of real-time, high-quality, spatiotemporal depth estimation from two-dimensional, color images. The process begins at 405 and ends at 495, but may repeat many times for each frame of video to be converted into volumetric video. This is an overall process that may be associated with the present patent. The remaining figures are sub-portions of this overall FIG. 4. FIG. 4 may apply to, include or be repeated for at time t−1 to time t.

Following the start at 405, the process begins with feature extraction at 410. This is associated with the feature extraction 340 function. As discussed above a convolutional neural network is preferably applied to transform two-dimensional, color image pairs into a stack of maps identifying features within the images. The two-dimensional feature maps are much easier to compare and work with than the entire images at full resolution. The images may be downscaled to lower resolution to enable still easier computational lift when identifying features. This feature identification may be used as anchor points for later feature matching (at 423, 580 and/or 610) to short circuit the process of identifying features, particularly those of humans within the images, for use in depth estimation.

The process continues with application of feature maps from a prior, corresponding frame of the video at 415. In this way, an image (or image pair) at time t may be compared with the same image (or image pair) at time t−1. Here, the optical flow 341 function operates to generate a visual warp of the differences between the two image pairs, then may operate in substantially the same manner to generate a warped depth map at 420. The feature maps that are compared may be intentionally at lower resolution to enable a still faster computational process. Sufficient fidelity to identify key features is likely sufficient to transform the prior warped depth map from time t−1 to time t. This warped depth map is a translation of the depth map from t−1 to time t, but relies upon the much-less-taxing comparison of two-dimensional feature maps from time t−1 to time t than the more-complex three-dimensional depth data to generate a rough estimate of the new depth, as a warped depth map.

This comparison is used to generate the warped depth map at 420 which may serve as one of the inputs to the process of generating a coarse depth map at 430. This process may take place substantially simultaneously with the segment and detect features for saliency map 423 and motion detection 427.

After the feature map for the present image (or pair of images) is created at 415 and substantially simultaneously with motion detection at 427, the process continues with the segment and detect features for saliency map at 423. Here, an artificial neural network is applied to identify the important features of the feature maps generated at 415. These important features are identified as a saliency map. As used herein, the phrase important features means human features such as face, hands, head, body, and facial features such as eyes, nose, eyebrows, and mouth within the image (or image pair). This process takes place in parts, with each part serving slightly-different purposes.

First, the neural network is applied to identify the location of a human character or body within the image (e.g. the frame of video). This focuses the remaining portions of this process on those locations to reduce the overall computational load for the remaining processes. The segmentation and feature detection process may focus on only those portions of the image (or image pair) that contains a human character or body. These make up the saliency map.

Next, the (or another) neural network is applied to identify the important features—as defined above—within the portions of the image where a human character or body was detected. This may be as simple as a flag identifying the pixels where a human body is present. This information is used later in the process of volumetric video creation more generally to apply a greater vertex density near the important features. This is because humans generally engage most with human characters in a given scene and a lack of vertex density (e.g. a blocky character) will appear most-unusual to a viewer. Volumetric video may, therefore, be optimized to increase vertex density near human characters and reduce it in background or other objects without sacrificing visual fidelity.

Next, an alpha matte is created—as discussed above—to be passed to still another portion of the volumetric video creation process. The alpha matte differentiates between “character” and “non-character” pixels, having an outline of the human character. Again, this information can be used later in the volumetric video creation process to generate a character's outline from a silhouette (e.g. the alpha matte) and to avoid undesired artifacts along the edges of the human (e.g. a background pixel being identified as a part of the body or vice versa).

Finally, the same alpha matte, showing the silhouette of one or more human characters in the scene is also provided to the motion detection 342 function because a silhouette is an excellent alternative source (in addition to a feature map) of information regarding motion from a frame at time t−1 to time t. This alpha matte, compared with another from a prior frame, may be excellent at indicating movement of objects, particularly human objects, within a frame at time t−1 to time t. So, it is passed to the motion detection 342 function for that purpose.

Substantially simultaneously, the motion detection 342 function operates to detect motion at 427. This detection may rely upon the saliency map generated at 423 for time t and a prior saliency map generated for a time t−1. Here, the motion detection compares the saliency (e.g. the human characters and non-human portions) to detect motion within the scene to designate where depth updates are necessary (e.g. movement has occurred) and to generate a motion intensity map. The motion intensity map identifies the relative intensity (e.g. minimal or no movement versus “intense” movement). Intense movement herein is a threshold level of movement between time t−1 and time t of sufficient speed to make use of saliency maps and prior depth information much-less valuable for estimating depth.

However, the motion intensity map does not make such a determination on an entire image basis. Instead, the motion intensity map identifies portions of the image (or image pair) that incorporate too much motion and portions that do not. In this way, the computational load may be applied only where necessary within a given image (or image pair). For example, if a character on screen moves his or her hand very quickly during a scene from left to right. That character's hand and the associated depth estimate may need to be re-calculated wholesale or nearly wholesale. However, the character themselves and the background likely do not move much from the immediately prior frame of video. So, portions of the image (or image pair) related to that character's hand may have their depth updated, while portions unrelated to the hand may still rely upon the prior frame of depth information.

Next, the coarse depth estimation 344 functions operate to generate a coarse depth map at 430 and to generate a confidence map at 435. The coarse depth map takes all of the motion intensity map, the saliency map and the warped depth maps generated at 427, 423, and 420, respectively. The confidence map is a two-dimensional array for a given input image (or image pair) that includes a “confidence” for the estimated depth of each pixel.

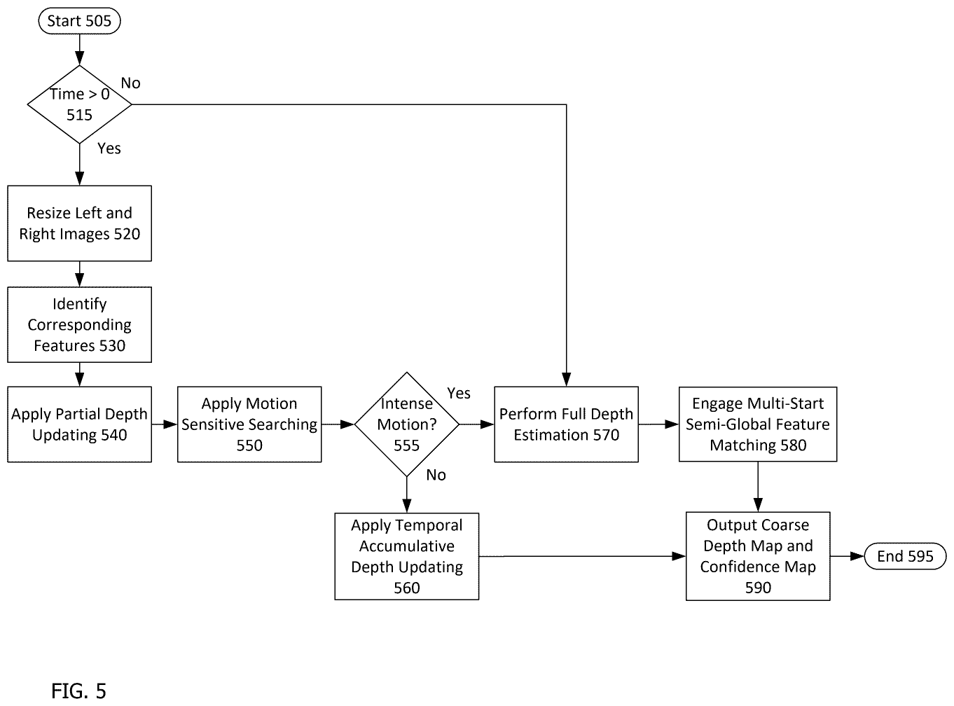

To accomplish this process, the coarse depth estimation 344 functions operate according to the process shown in FIG. 5. FIG. 5 is a flowchart of a process of coarse depth estimation. The process begins at 505 and ends at 595, but may repeat many times for each frame of video to be converted into volumetric video. FIG. 5 may apply to, include or be repeated for at time t−1 to time t.

Following the start at 505, the process begins with a determination whether time is greater than zero (“no” at 515), meaning, that the volumetric capture has not only just begun (e.g. run-time of the capture process is greater than zero). If time t is zero, then depth data for the entire frame of video must be generated from scratch, so the process proceeds to performance of full depth estimation at 570. If time t is greater than zero (“yes” at 515), then the process of intelligently updating the existing depth map begins. This begins with resizing the left and right images of the image pair at 520, such as to reduce their resolution to create lower resolution feature maps. Here, the complexity of the images is lowered significantly, and feature match searches are performed at 530. Step 520 may be repeated iteratively until a low enough resolution is obtained for step 530. This may be done iteratively because features may not be evident in lower-resolution and slightly-less resolution reduction may be required to perform featuring matching to identify corresponding features at 530. But, if a match can take place with sufficient confidence at lower resolution, this again lowers computational complexity and enables faster operation.

Next, or in addition, partial depth updating may be applied at step 540. This step 540 may take the saliency maps generated at 423 and elect to completely ignore areas not identified as having important features (e.g. human features). This enables depth estimation to only apply in areas where humans exist or at pixels having an outline of the human character. Because background portions are ignored, the scene may be considered in higher resolution and with a larger field of view to accommodate larger motion by the human characters.

Next, the motion sensitive searching process or step 550 is applied which divides the image into a grid of a plurality of patches and estimates the depth of each patch independently of the other. And, in addition, step 550 may estimate the depth of each patch using a different estimation process. So, where motion is occurring, the warped depth map may be used as a basis of depth estimation, but in addition the alpha matte and saliency maps may be applied to better-refine the “edges” of the human character (e.g., pixels including an outline of the human character) to estimate depth. In areas where background is present, with no important features, and no human character; the warped depth map may be lightly-updated because it is unlikely that the depth has changed significantly from frame to frame. Depth estimation processes may be applied iteratively to each patch to further refine the depth estimation, or patches may be sub-divided for more granular estimation of depth.

If motion between frames is too great or is intense motion at decision block 555, a full depth estimation process may begin for a given patch or patches to accommodate those drastic changes, but without requiring full depth estimation of the entire image, merely requiring estimation of the patch itself at step 570. But, this is only the process for patches for an entire image (or pair of images) when time greater than zero (“yes” at 515) and “yes” at step 555. Then, the process continues to “yes” at 555.

When intense motion is not detected (“no” at 555), the temporal accumulative depth updating is applied at step 560. This step 560 is used if motion exceeds a threshold for a given image and/or patch within an image. Here, at step 560 the depth map from time t−1 is warped into the warped depth map. This warped depth map is a starting point for a depth search for the frame at time t. The feature maps from time t−1 and t are then compared and matched. Thereafter, the warped depth map is updated, as needed, based upon the feature maps. This process takes into account the change in the images and leans upon it to update the depth maps and confidence map. In this way, a coarse depth map is created for the entire image (or pair of images) along with a confidence map comprising the confidence associated with the depth estimated for each pixel in the image (or pair of images).

When intense motion is detected (“yes” at 555) or when time is zero (“no” at 515), then a full depth estimation is performed at step 570. This process of step 570 is called multi-start, semi-global feature matching at 580. This process is described in more detail with reference to FIG. 6. FIG. 6 is a flowchart of a process of multi-start, semi-global feature matching. The process begins at 605 and ends at 695, but may repeat many times for each frame of video to be converted into volumetric video. FIG. 6 may apply to, include or be repeated for at time t−1 to time t.

Following the start at 605, the process begins with a one-dimensional global feature matching search at 610. This may be or include steps, data and/or functions of step 580, Here, a one-dimensional search is chosen because the image pairs for a left camera and a right camera are presumed to be able to be matched almost entirely. This is because the cameras are close in proximity and filming the same captured scene, such as being within 0.2 and 3 feet of each other. One dimensional searching can be top to bottom of the image in one column or side-to-side in the image in one row.

The best matches for each pixel are stored at 620, then the best match is masked out at 630. Masking out at 630 may include hiding the matching pixels from subsequent searching; masking out matching pixels for each pixel in the one image as compared to a prior image to generate a plurality of match possibilities; and/or matching out occluded pixels meeting a threshold are masked out of a depth cross-view refinement process to not accidentally introduce still more undesired artifacts.

Then, a determination is made whether two searches have completed at 635. If not (“no” at 635, only one search so far), then the next-best match is chosen as a starting point at 640, and the process begins again with one-dimensional feature matching at 610.

After two searches are complete (“yes” at 635), a final search is performed from the initial position of each pixel itself (e.g. a pixel in the left image is searched beginning in the same pixel in the right image) at 650. The best pixel matches for each pixel are stored at 660. Now, feature matching searches are performed on the two-dimensional images to find near matches at 670. The matching pixels and confidence for the matches are stored at 680. Finally, a confidence-based merge is used to select the best-matching pixels from each of the three trials at 690 (e.g., from three trails at steps 630-670 or steps 650-670). Here, the best match is used for each pixel, which results in a robust and accurate depth estimate. Unfortunately, this process is computationally intensive, so it is only used in those cases where ground-up depth estimation is necessary. More importantly, it can be performed more quickly, efficiently and using less power and computing resources.

The process then ends at 695.

Returning to FIG. 5, the coarse depth map and confidence map are output at 590, and then the process ends at 595.

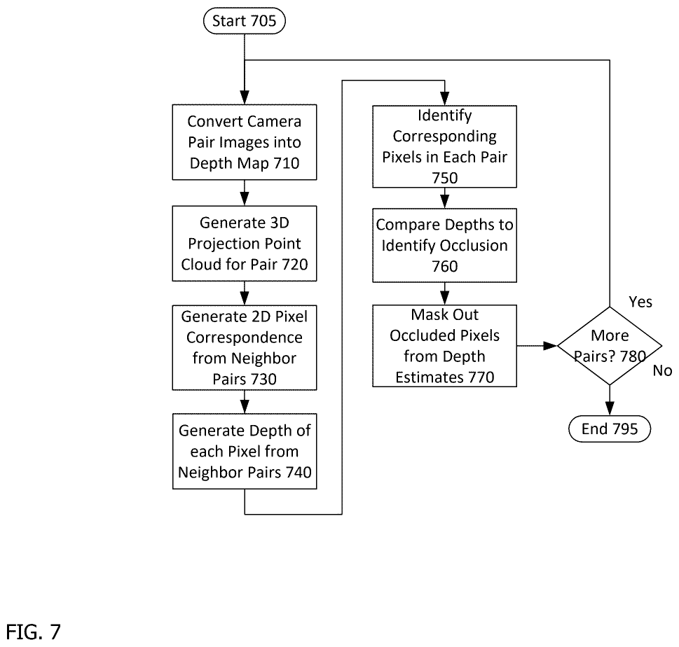

Returning to FIG. 4, the process continues with refinement of the coarse depth map using other views at step 440. Here, the process uses the availability of other camera pair views of the same frame to further refine the depth estimate. This process is described in detail with reference to FIG. 7. FIG. 7 is a flowchart of a process of cross-view refinement. The process begins at 705 and ends at 795, but may repeat many times for each frame of video to be converted into volumetric video. FIG. 7 may apply to, include or be repeated for at time t−1 to time t.

Following the start at 705, the process begins with conversion of a pair of images into a depth map at 710. These are the images for which the refinement is being made. Here, this is done so that the depth map may be converted into a projection point cloud at 720 for comparison with other depth maps from other camera pairs or point clouds from those other camera pairs. Step 720 may compare depth maps of projection points or clouds from one camera pair to those of other camera pairs,

Next, the two-dimensional correspondence is made from neighbor camera pairs at 730. This correspondence may rely upon a projected (x, y) position for each pixel in the corresponding image pairs of neighbor camera pairs. At step 730 depth for each corresponding pixel is generated using the neighbor pair data at 740. Here, a projection of the expected depth from the original camera pair is provided using data from another camera pair. The cross-comparison enables a double-check on depth, and using multiple camera pairs, this double-check across a group of cameras can result in quite accurate depth comparisons as compared to prior systems.

Next, the corresponding pixels of a camera pair from the first camera view may be identified in each corresponding camera pair at 750. And, the depth of each pixel from the original camera pair view may be mapped onto the neighboring camera pair view.

These may be compared to identify occlusion at 760. Here, the absence of a corresponding pixel from the original image pair may be detected in another image pair because the depth is likely to be incorrect in the original view, but may be correct (or near-correct) in the other camera pair views or multiple other camera pair views. The resulting occlusion map, generated at 760, identifying the pixels that are not visible in both images of the original camera pair. These pixels that are identified as occluded must be more than a threshold difference in their depth. Preferably, this threshold indicates that the depth of the other camera pair(s) view is shallower than the projected depth (e.g. hitting an object, like a foreground person) than the projected depth from the coarse depth map from the original camera pair. This suggests that the pixel is not visible in the associated neighbor camera view and that depth should not be updated using that view (e.g. an object is between the neighbor camera pair and the pixel identified in the original camera pair).

The occluded pixels, meeting that threshold, are masked out of depth cross-view refinement process at 770 to not accidentally introduce still more undesired artifacts from the depth estimates. Here the current pixels of a camera pair from the current camera view may be identified in a prior camera pair view to be masked out if they are detected as having an absence of corresponding pixel in the original image pair. This may also happen when processing or using the prior image pair, when the prior image pair has pixels that are absent in the prior image pair but exist in the current image pair. This allows the depth that is likely to be incorrect in the one camera pair view to be corrected (or near-corrected) in the other camera pair views or multiple other camera pair views.

If more pairs of pixels are present in the two pairs of images (“yes” at 780), then the process continues for those additional pixels at noted for step 710. If not (“no” at 780), then the cross-view refinement process is complete as noted for step 795.

The cross-view refinement can be used to act as a check on the overall depth estimation process and to further refine the estimated depth. Following all pairs (“no” at 780), the process then ends at 795.

Returning to FIG. 4, the process continues with denoising the depth map at step 450. This step applies a neural network trained to suppress Gaussian noise introduced by ambient interference that is resultant from higher CMOS sensitivity. Capturing high-speed motion video often requires a higher CMOS sensitivity which has the undesirable effect of introducing visual artefacts. This step operates effectively as a filter to minimize such visual artefacts, and/or jiggering, flickering, and other effects that can occur and to smooth the overall depth (and resultant point cloud and/or mesh) of the scene. The Gaussian neural network of step 450 may rely in part upon the confidence map created at the coarse depth estimation process for each pixel. The confidence can assist in identifying pixels that are more-likely to be artefacts or otherwise simply noise.

The process then ends at 495.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A system for real-time, spatiotemporally consistent depth estimation, the system comprising a processor and memory, the memory storing non-transitory computer instructions which when executed by a processor cause the processor to:
receive an image pair, comprising a pair of two-dimensional, color images of a captured scene, wherein the image pair is one in a stream of frames of image data suitable for conversion into volumetric video;
generate a pair of feature maps identifying a plurality of features within the image pairs;
compare other image pairs, immediately preceding image pair in time, to identify a direction and magnitude of changes in the feature maps as a warped depth map;
segment the feature maps to create saliency maps identifying important features of the feature maps;
compare the feature maps and saliency maps for each of the image pairs and another image pair, immediately preceding each of the image pairs, to generate motion intensity maps;
generate a coarse depth map for the image pairs from the warped depth map, the saliency maps, and the motion intensity maps along with a confidence map identifying a confidence associated with each coarse pixel depth within the coarse depth map;
perform cross-view refinement of the coarse depth map reliant upon at least one other image pair of two-dimensional, color images of the scene to create a refined depth map; and
denoise the refined depth map to create denoised refined depth map.

2. The system of claim 1 wherein the confidence is an indicator of surety of each coarse pixel depth within the coarse depth map for the image pair.

3. The system of claim 1 wherein the instructions further cause the processor to output the refined depth map and corresponding to the image pair for combination into volumetric video.

4. The system of claim 1 wherein the instructions further cause the processor to store the refined depth map in conjunction with the image pair for combination into volumetric video.

5. The system of claim 1 wherein generating the coarse depth map comprises:
resizing the feature maps to reduce their resolution to create lower resolution feature maps;
detecting matches of features within the lower resolution feature maps;
performing coarse depth estimation for at least a portion of the image pair in a selected one of three ways:
estimating depth for only human features within the feature maps, leaving background portions at the same depth as a prior frame in the stream of frames;
estimating depth in a patch-wise fashion for portions of the feature maps wherein the motion intensity map indicates motion is minimal, applying temporal accumulative depth updating; and
applying a full depth estimation process in case wherein the motion intensity map indicates motion is more than minimal or in a first frame in the stream of frames.

6. The system of claim 5 wherein the temporal accumulative depth updating relies upon the motion intensity maps, the unified saliency maps, and a warped depth map from a preceding frame in the stream of frames to generate the coarse depth map and the confidence map.

7. The system of claim 5 wherein the full depth estimation process comprises:
matching each pixel in one image of the image pair with another image of the image pairs in one dimension along with an associated confidence score;
beginning a two-dimensional local search within the one image for a pixel found in the another image from a pixel identified as matching;
note the matching pixels;
mask out the matching pixels from subsequent searching;
repeating the matching, two-dimensional local searching processes, noting the matching pixels, and masking out the matching pixels for each pixel in the one image to generate a plurality of match possibilities; and
merge the results of the match possibilities in two dimensions for the image pair to select a best feature match and associated confidence score.

8. The system of claim 1 wherein the instructions rely upon one or more convolutional, artificial, or deep neural networks trained upon image pairs and corresponding depth maps.

9. A method for real-time, spatiotemporally consistent depth estimation comprising:
receiving an image pair, comprising a pair of two-dimensional, color images of a scene, the image pair one in a stream of frames of image data suitable for conversion into volumetric video;
generating a pair of feature maps identifying a plurality of features within the image pairs;
comparing another image pair, immediately preceding the image pair in time, to identify a direction and magnitude of changes in the feature maps as a warped depth map;
segmenting the feature map to create saliency maps identifying important features of the feature maps;
comparing the feature maps and saliency maps for each of the image pairs and another image pair, immediately preceding each of the image pairs, to generate a motion intensity map;
generating a coarse depth map for the image pair from the warped depth map, the saliency maps, and the motion intensity maps along with a confidence map identifying a confidence associated with each coarse pixel depth within the coarse depth map;
performing cross-view refinement of the coarse depth map reliant upon at least one other pair of two-dimensional, color images of the scene to create a refined depth map; and
denoising the refined depth map.

10. The method of claim 9 wherein the confidence is an indicator of surety of each coarse pixel depth within the coarse depth map for the image pair.

11. The method of claim 9 further comprising outputting the refined depth map and corresponding to the image pair for combination into volumetric video.

12. The method of claim 9 further comprising storing the refined depth map in conjunction with the image pair for combination into volumetric video.

13. The method of claim 9 generating the coarse depth map comprises:
resizing the feature maps to reduce their resolution to create lower resolution feature maps;
detecting matches of features within the lower resolution feature maps;
performing coarse depth estimation for at least a portion of the image pair in a selected one of three ways:
estimating depth for only human features within the feature maps, leaving background portions at the same depth as a prior frame in the stream of frames;
estimating depth in a patch-wise fashion for portions of the feature maps wherein the motion intensity map indicates motion is minimal, applying temporal accumulative depth updating; and
applying a full depth estimation process in case wherein the motion intensity map indicates motion is more than minimal or in a first frame in the stream of frames.

14. The method of claim 13 wherein the temporal accumulative depth updating relies upon the motion intensity maps, the unified saliency maps, and a warped depth map from a preceding frame in the stream of frames to generate the coarse depth map and the confidence map.

15. The method of claim 13 wherein the full depth estimation process comprises:
matching each pixel in one image of the image pair with another image of the image pairs in one dimension along with an associated confidence score;
beginning a two-dimensional local search within the one image for a pixel found in the another image from a pixel identified as matching;
note the matching pixels;
mask out the matching pixels from subsequent searching;
repeating the matching, two-dimensional local searching processes, noting the matching pixels, and masking out the matching pixels for each pixel in the one image to generate a plurality of match possibilities; and
merge the results of the match possibilities in two dimensions for the image pair to select a best feature match and associated confidence score.

16. The method of claim 9 reliant upon one or more convolutional, artificial, or deep neural networks trained upon image pairs and corresponding depth maps.

17. Apparatus comprising a storage medium storing instructions, which when executed by a processor will cause the processor to:
receive an image pair, comprising a pair of two-dimensional, color images of a captured scene, wherein the image pair is one in a stream of frames of image data suitable for conversion into volumetric video;
generate a pair of feature maps identifying a plurality of features within the image pairs;
compare other image pairs, immediately preceding image pair in time, to identify a direction and magnitude of changes in the feature maps as a warped depth map;
segment the feature maps to create saliency maps identifying important features of the feature maps;
compare the feature maps and saliency maps for each of the image pairs and another image pair, immediately preceding each of the image pairs, to generate motion intensity maps;
generate a coarse depth map for the image pairs from the warped depth map, the saliency maps, and the motion intensity maps along with a confidence map identifying a confidence associated with each coarse pixel depth within the coarse depth map;
perform cross-view refinement of the coarse depth map reliant upon at least one other image pair of two-dimensional, color images of the scene to create a refined depth map; and
denoise the refined depth map to create denoised refined depth map.

18. The apparatus of claim 17 wherein the instructions further cause the processor to store the refined depth map in conjunction with the image pair for combination into volumetric video.

19. The apparatus of claim 17 wherein generating the coarse depth map comprises:
resizing the feature maps to reduce their resolution to create lower resolution feature maps;
detecting matches of features within the lower resolution feature maps;
performing coarse depth estimation for at least a portion of the image pair in a selected one of three ways:
estimating depth for only human features within the feature maps, leaving background portions at the same depth as a prior frame in the stream of frames;
estimating depth in a patch-wise fashion for portions of the feature maps wherein the motion intensity map indicates motion is minimal, applying temporal accumulative depth updating; and
applying a full depth estimation process in case wherein the motion intensity map indicates motion is more than minimal or in a first frame in the stream of frames.

20. The apparatus of claim 17 wherein the temporal accumulative depth updating relies upon the motion intensity maps, the unified saliency maps, and a warped depth map from a preceding frame in the stream of frames to generate the coarse depth map and the confidence map.
